(19) United States
(12) Patent Application Publication
(10) Pub. No.: US 2009/0020907 A1
(43) Pub. Date: Jan. 22, 2009

(54) TENTER CLIP AND SOLUTION CASTING METHOD

(75) Inventors: Toshinao Arai, Kanagawa (JP); Hitoshi Ikeda, Kanagawa (JP); Naoya Koyota, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Minato-ku, Tokyo (JP)

(21) Appl. No.: 11/817,790

(22) PCT Filed: Apr. 1, 2006
(86) PCT No.: PCT/JP2006/304418

§ 371 Date: Sep. 4, 2007

(30) Foreign Application Priority Data
Mar. 4, 2005 (JP) 2005-061238

(51) Int. Cl. B29D 7/01

(52) U.S. Cl. 264/216; 425/66

(57) ABSTRACT

A dope is prepared from TAC, solvent and the like. The dope is cast from a casting die (31) onto a belt (34) to form a casting film (69). The casting film (69) is peeled as a wet film (74) from the belt (34). The wet film (74) is transported to a tenter device (35), in which both side edge portions are clipped by tenter clips (100). The content of the remaining solvent in the wet film 74 is determined to 100 wt. % on dry basis. The tenter clips (100) (temperature, 40° C.) has a support surface (100a) for supporting the side edge portion of the wet film 74 thereon. A surface tension of the support surface (100a) is 3.1×10⁻² N/m, a surface roughness Ra of the support surface (100a) is 0.3 μm, and a surface hardness of the holding surface (100a) is 700 Hv. Therefore, the adhesion of the foreign materials is reduced. The wet film (74) is dried with stretching in the widthwise direction by the tenter device (35), so as to obtain a TAC film (82).

### TECHNICAL FIELD

The present invention relates to a tenter clip and a solution casting method in which a tenter device including the tenter clip is used.

### BACKGROUND ART

A cellulose acylate film is formed from cellulose acylate. For example, especially cellulose triacetate (hereinafter TAC) film is formed from TAC whose averaged acetylation degree is in the range of 58.0% to 62.5%. The TAC film is used as a film base of a film material, such as a photosensitive material, since having strength and inflammability. Further, the TAC film is excellent in optical isotropy, and therefore used as a protective film in a liquid crystal display whose market becomes larger in recent years.

The TAC film is usually produced by a solution casting method, in which the produced film is more excellent in physical properties, such as optical properties and the like, than other film production methods. For the solution casting method, polymer is dissolved to a mixture solvent in which dichloromethane or methyl acetate is main solvent compound, and thus a dope as a polymer solution is prepared. Then the dope is cast from a casting die onto a support so as to form a casting film, while a bead of the dope is formed between the casting die and the support. When he casting film has a self-supporting property, the casting film is peeled as a wet film from the support.

The wet film is transported to a tenter device. In the tenter device, tenter clips hold both side edge portions of the wet film and moves to transport the wet film. At this time, the wet film is stretched or relaxed in a widthwise direction and dried simultaneously. Note that the tenter clips are usually attached to a chain, and endlessly move by circularly rotating the chain. After releasing the wet film, the tenter clips passes on a return side of the chain towards an entrance of the tenter device, and then clip to hold the wet film in a clipping position. The wet film fed out from the tenter device is dried furthermore to a film. Then the film is wound up. (for example, Japan Institute of Invention and Innovation (JIII) Journal of Technical Disclosure No. 2001-1745)

Further, in recent years, the TAC film is used as several sorts of the optical films in the liquid crystal display. For example, the market of the retardation film having birefringence becomes larger. Further it is necessary to decrease the temperature of the tenter clips for preventing near clipped part in the wet film the foaming which occurs in accordance with the increase of the volatile contents. However, in this case, the pollution occurs. For example, the vaporized plasticizer precipitates easily on the clips, and the precipitated plasticizer sometimes grows up. In this condition, the clipping is difficult since the tenter lips just only pat the wet film and the precipitated plasticizer prevents the clipping. Otherwise, in the clipped part, holes are formed to cause the tear of the wet film. Further, a drying air transfers the pollution materials as foreign materials, which sometimes makes the quality of the film bad. Therefore, a heater is provided for the clips to prevent the pollution by the plasticizer, and the foreign materials are removed by a sprayed gas or a liquid, or with use of a brush. (For example, Japanese Patent Laid-Open Publication No.11-077719).

Since the market of the optical film becomes larger, the increase of the productivity of the TAC film is required. Thus the production speed of the TAC film becomes higher. However, in this case, the content of the volatile materials in the wet film becomes larger. If the volatile material vaporizes in the tenter device, it adheres to the clipping surfaces of the tenter clips and transferred (or copied) to the clipped part of the film surface. Thus the volatile material remains on the obtained TAC film, and makes the optical properties bad.

In the patent publication No.H11-077719, it is designated that the tener clips clip the wet film containing a large amount of the volatile material. In this case, when the heater is provided o heat the tenter clips, the foaming sometime occurs in the wet film. Further, in the publication No.H11-077719, there is a cleansing device with a brush for cleansing the tenter clip in a return side of the chain. In this case, since the additive materials (the plasticizer and the like) precipitate in the devices, the film production machine must be stopped several times to exchange and clean the clips. Furthermore, if the heating device or the cleansing device is provided for the tenter clips, the tenter device has the complicated structure and becomes larger. Thus the const for the maintenance becomes higher.

An object of the present invention is to provide a tenter clip for a tenter device, in which the adherence of the foreign materials and the like on a surface of the tenter clip is reduced.

Another object of the present invention is to provide a solution casting method by which an excellent film in optical properties can be continuously produced with use of a tenter clip for a tenter device, in which the adherence of the foreign materials and the like on a surface of the tenter clip is reduced.

### DISCLOSURE OF INVENTION

In order to achieve the object and the other object, a tenter clip of a tenter device clips both side edge portions of a film in a widthwise direction to hold the film, while the tenter device stretches the film. The tenter clip has a clipping surface for clipping each of the side edge portions in the clipping. A surface tension of the clipping surface is in the range of 3.0×10⁻² N/m to 3.3×10⁻² N/m.

Preferably, surface hardness of the clipping surface is in the range of 400 Hv to 800 Hv. Further, surface roughness Ra of the clipping surface is in the range of 0.05 μm to 1 μm. A plating is made on the clipping surface.

Preferably, the tenter clip has a bar-like member swinging from a first position to a second position so as to press each of the side edge portions of the wet film onto the support surface in performance of the clipping.

In a solution casting method of the present invention, a dope containing polymer and solvent is cast on a support to form a casting film. Then the casting film is peeled as a wet film from the support. In a tenter device, side edge portions of the wet film with tenter clips. A clipping surface of each tenter clip has surface tension in the range of 3.0×10⁻² N/m to 3.3×10⁻² N/m. the wet film is stretched by moving the tenter clip on a track. The wet film is released from the tenter clip after the stretching so as to be a film.

In a preferable embodiment of the solution casting method, surface hardness of the clipping surface is in the range of 400 Hv to 800 Hv. Further, surface roughness Ra of the clipping surface is in the range of 0.05 μm to 1 μm. A plating is made on the clipping surface.

Further, in a preferable embodiment of the solution casting method, the tenter clip has a bar-like member. When the clipping is performed, the bar-like member swings from first position for releasing the wet film to a second position for clipping the wet film to press the side edge portion of the wet film onto the support member when the clipping is performed.

In a preferable embodiment of the solution casting method, the wet film is dried by blowing a wind near the tenter clip between holding and releasing the wet film. A blowing temperature of the wind is in the range of 30° C. to 70° C.

Preferably, a content of solvent in the wet film at the clipping is in the range of 80 wt. % to 200 wt. % on dry basis. Further, a temperature of the tenter clip is in the range of 0° C. to 60° C.

According to the tenter clip of the present invention, since a surface tension of the clipping surface being in the range of 3.0×10⁻² N/m to 3.3×10 ⁻² N/m, the adherence of the foreign materials and the like on a surface of the tenter clip is reduced.

Further, according to the tenter clip of the present invention, (1) surface hardness of the clipping surface is in the range of 400 Hv to 800 Hv., (2) surface roughness Ra of the clipping surface is in the range of 0.05 μm to 1 μm, and (3) a plating is made on the clipping surface. Therefore, the clipping surface is hardly scratched, and thus the adherence of the foreign materials and the like on a surface of the tenter clip is reduced more effectively.

According to the solution casting method of the present invention, since a surface tension of the clipping surface being in the range of 3.0×10⁻² N/m to 3.3×10⁻² N/m, the adherence of the foreign materials and the like on a surface of the tenter clip is reduced, and the surface defect is prevented.

Further, according to the solution casting method of the present invention, (1) surface hardness of the clipping surface is in the range of 400 Hv to 800 Hv., (2) surface roughness Ra of the clipping surface is in the range of 0.05 μm to 1 μm, and (3) a plating is made on the clipping surface. Therefore, the clipping surface is hardly scratched, and thus the adherence of the foreign materials and the like on a surface of the tenter clip is reduced more effectively, and the surface defect is prevented.

In the solution casting method, the wet film is dried by blowing a wind near the tenter clip between holding and releasing the wet film. A blowing temperature of the wind is in the range of 30° C. to 70° C. Therefore, the organic solvent vapor doesn't liquidized on a surface of the tenter clip, and there are no influence on drying the wet film.

In the solution casting method, a content of solvent in the wet film at the clipping is in the range of 80 wt. % to 200 wt. % on dry basis. Thus productivity can be made higher. Further, a temperature of the tenter clip is in the range of 0° C. to 60° C. Thus the rapid evaporation of the organic solvent is reduced, and therefore the foaming is prevented. As a result, the surface conditions of the produced film are extremely excellent in surface conditions.

As a result of the consideration of the inventor, the inventor found followings. The adhesive force of the tenter clip to the wet film can be reduced by decreasing a surface energy of the clipping surface of the tenter clip. Otherwise, the increase of the surface roughness makes the contact area to the wet film smaller such that the adhesive force to the wet film may be decreased. Furthermore, if the gas concentration of the additive (such as plasticizer and the like) near the tenter clips is decreased, the precipitation of the volatile materials (such as plasticizer and the like) on the tenter clip is reduced.

### BRIEF DESCRIPTION OF DRAWINGS

FIG. 1 is a schematic diagram of a film production line as an embodiment of a solution casting method of the present invention;

FIG. 2 is a schematic diagram of a tenter device having tenter clips of the present invention.

FIG. 3 is a schematic diagram of the tenter clips

### BEST MODE FOR CARRYING OUT THE INVENTION

In followings, embodiments of the present invention will be explained. However, the present invention is not restricted in the embodiments.

### [Raw Materials]

As polymer of this embodiment, cellulose acylate is preferable, and triacetyl cellulose (TAC) is especially preferable. TAC may be produced from cotton linter or cotton pulp, or a mixture of materials respectively obtained from cotton linter and cotton pulp, and preferable TAC is produced from cotton linter. It is preferable in cellulose acylate that the degree of substitution of acyl groups for hydrogen atoms on hydroxyl groups of cellulose preferably satisfies all of following formulae (I)-(III). In these formulae (I)-(III), A is the degree of substitution of the acetyl groups for the hydrogen atoms on the hydroxyl groups of cellulose, and B is the degree of substitution of the acyl groups for the hydrogen atoms while each acyl group has carbon atoms whose number is from 3 to 22. Note that at least 90 wt. % of TAC is particles having diameters from 0.1 mm to 4 mm.

2.523 A+B≦3.0 (I)

0≦A≦3.0 (II)

0≦B≦2.9 (III)

Further, polymer to be used in the present invention is not restricted in cellulose acylate.

A glucose unit constructing cellulose with β-1,4 bond has the free hydroxyl groups on 2^{nd}, 3^{rd} and 6^{th} positions. Cellulose acylate is polymer in which, by esterification, the hydrogen atoms on the part or all of the hydroxyl groups are substituted by the acyl groups having at least two carbon atoms. The degree of acylation is the degree of the esterification of the hydroxyl groups on the 2^{nd}, 3^{rd}, 6^{th} positions. In each hydroxyl group, if the esterification is made at 100%, the degree of acylation is 1. Therefore, if all of the three hydroxyl groups is esterified at 100%, the degree of acylation is 3.

Herein, if the acyl group is substituted for the hydrogen atom on the 2^{nd} position in a glucose unit, the degree of the acylation is described as DS2 (the degree of substitution by acylation on the 2^{nd} position), and if the acyl group is substituted for the hydrogen atom on the 3^{rd} position in the glucose unit, the degree of the acylation is described as DS3 (the degree of substitution by acylation on the 3^{rd} position). Further, if the acyl group is substituted for the hydrogen atom on the 6^{th} position in the glucose unit, the degree of the acylation is described as DS6 (the degree of substitution by acylation on the 6^{th} position). The total of the degree of acylation, DS2+DS3+DS6, is preferably 2.00 to 3.00, particylarly 2.22 to2.90, and especially 2.40 to 2.88. Further, DS6/(DS2+DS3+DS6) is preferably at least 0.28, particularly at least 0.30, and especially 0.31 to 0.34.

In the present invention, the number and sort of the acyl groups in cellulose acylate may be only one or at least two. If there are at least two sorts of acyl groups, one of them is preferable the acetyl group. If the hydrogen atoms on the 2^{nd}, 3^{rd} and 6^{th} hydroxyl groups are substituted by the acetyl groups, the total degree of substitution is described as DSA, and if the hydrogen atoms on the 2^{nd}, 3^{rd} and 6^{th} hydroxyl groups are substituted by the acyl groups other than acetyl groups, the total degree of substitution is described as DSB. In this case, the value of DSA+DSB is preferably 2.22 to 2.90, especially 2.40 to 2.88. Further, DSB is preferably at least 0.30, and especially at least 0.7. According to DSB, the percentage of the substitution on the 6^{th} position to that on the 2^{nd}, 3^{rd} and 6^{th} positions is at least 20%. However, the percentage is preferably at least 25%, particularly at least 30%, and especially at least 33%. Further, DSA+DSB of the 6^{th} position of the cellulose acylate is preferably at least 0.75, particularly at least 0.80, and especially at least 0.85. When these sorts of cellulose acylate are used, a solution (or dope) having preferable solubility can be produced, and especially, the solution having preferable solubility to the non-chlorine type organic solvent can be produced. Further, when the above cellulose acylate is used, the produced solution has low viscosity and good filterability.

Cellulose as raw material of acylate cellulose is may be obtained from one of linter cotton and pulp cotton. However, the cellulose is preferably obtained from linter cotton.

In cellulose acylate, the acyl group having at least 2 carbon atoms may be aliphatic group or aryl group. Such cellulose acylate is, for example, alkylcarbonyl ester and alkenylcarbonyl ester of cellulose. Further, there are aromatic carbonyl ester, aromatic alkyl carbonyl ester, or the like, and these compounds may have substituents. As preferable examples of the compounds, there are propionyl group, butanoyl group, pentanoyl group, hexanoyl group, octanoyl group, decanoyl group, dodecanoyl group, tridecanoyl group, tetradecanyol group, hexadecanoyl group, octadecanoyl group, iso-butanoyl group, t-butanoyl group, cyclohexanecarbonyl group, oleoyl group, benzoyl group, naphthylcarbonyl group, cinamoyl group and the like. Among them, the particularly preferable groups are propionyl group, butanoyl group, dodecanoyl group, octadeqanoyl group, t-butanoyl group, oleoyl group, benzoyl group, naphthylcarbonyl group, cinamoyl group and the like, and the especially preferable groups are propionyl group and butanoyl group.

Further, as solvents for preparing the dope, there are aromatic hydrocarbons (for example, benzene, toluene and the like), hydrocarbon halides (for example, dichloromethane, chlorobenzene and the like), alcohols (for example, methanol ethanol, n-propanol, n-butanol, diethyleneglycol and the like), ketones (for example, acetone, methylethyl ketone and the like), esters (for example, methyl acetate, ethyl acetate, propyl acetate and the like), ethers (for example, tetrahydrofuran, methylcellosolve and the like) and the like. Note that the dope is a polymer solution or dispersion in which a polymer and the like is dissolved to or dispersed in the solvent.

The solvents are preferably hydrocarbon halides having 1 to 7 carbon atoms, and especially dichloromethane. Then in view of the dissolubility of cellulose acylate, the peelability of a casting film from a support, a mechanical strength of a film, optical properties of the film and the like, it is preferable that one or several sorts of alcohols having 1 to 5 carbon atoms is mixed with dichloromethane. Thereat the content of the alcohols to the entire solvent is preferably in the range of 2 mass % to 25 mass %, and particularly in the range of 5 mass % to 20 mass %. Concretely, there are methanol, ethanol, n-propanol, iso-propanol, n-butanol and the like. The preferable examples for the alcohols are methanol, ethanol, n-butanol, or a mixture thereof.

By the way, recently in order to reduce the effect to the environment to the minimum, the solvent composition when dichloromethane is not used is progressively considered. In order to achieve this object, ethers having 4 to 12 carbon atoms, ketones having 3 to 12 carbon atoms, esters having 3 to 12 carbons, and alcohols having 1 to 12 carbons are preferable, and a mixture thereof can be used adequately. For example, there is a mixture of methyl acetate, acetone, ethanol and n-butanol. These ethers, ketones, esters and alcohols may have the ring structure. Further, the compounds having at least two of functional groups in ethers, ketones, esters and alcohols (namely, —O—, —CO—, —COO— and —OH) can be used for the solvent.

Note that the detailed explanation of cellulose acylate is made from [0140] to [0195] in Japanese Patent Laid-Open Publication No. 2005-104148, and the description of this publication can be applied to the present invention. Note that the detailed explanation of the solvents and the additive materials of the additive (such as plasticizers, deterioration inhibitors, UV-absorptive agents, optical anisotropy controllers, dynes, matting agent, release agent, retardation controller and the like) is made from [0196] to [0516] in Japanese Patent Laid-Open Publication No. 2005-104148.

### [Dope Production Method]

The solvent is sent to a dissolution tank. Then a necessary amount of TAC in a hopper is measured and sent with measuring to a dissolution tank. Then a necessary amount of the additive solution is sent from an additive tank to the dissolution tank. Note that if the additive is in the liquid state in the room temperature, it may be fed in the liquid state to the dissolution tank without preparing for the additive solution. Otherwise, if the additive is in the solid state in the room temperature, it may be fed in the solid state to the dissolution tank with use of a hopper and the like. If plural sorts of additive compounds are used, the additive containing the plural additive compounds may be accumulated in the additive tank altogether. Otherwise plural additive tanks may be used so as to contain the respective additive compounds, which are sent through independent pipes to the dissolution tank.

In the above explanation, the solvent, TAC, the additive are sequentially sent to the dissolution tank. However, the sending order is not restricted in it. For example, after the necessary amount of TAC is sent with measurement to the dissolution tank, the feeding of the preferable amount of the solvent may be performed. Further, it is not necessary that the additive is previously sent in the dissolution tank, and they may be added to a mixture of TAC and the solvent.

The dissolution tank is provided with a jacket covering over an outer surface of the dissolution tank and first and second stirrer which are rotated by respective motors. The first stirrer preferably has an anchor blade, and the second stirrer is preferably an eccentric stirrer of a dissolver type. The inner temperature in the dissolution tank is controlled with use of the heat transferring medium flowing in the jacket. The preferable inner temperature is in the range of −10° C. to 55° C. At least one of the first and second stirrers is adequately chosen for performing the rotation. Thus a swelling liquid in which TAC is swollen in the solvent is obtained. Note that the second stirrer may be omitted. However, as in this embodiment, the second stirrer is preferably provided.

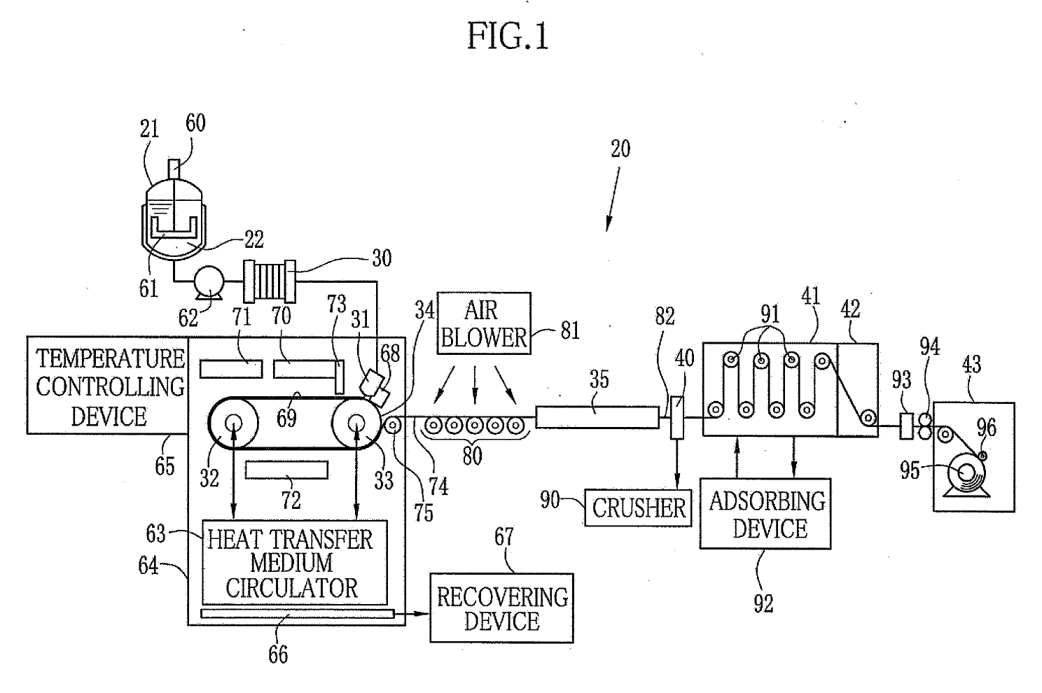

The swelling liquid in the dissolution tank is sent with use of pump to a heating device. Preferably, the heating device is a pipe with a jacket, and further pressurizes the swelling liquid. During only the heating or both of the heating and pressurizing of the swelling liquid, the dissolution of TAC proceeds such that a polymer solution may be obtained. Note that the polymer solution may be a solution in which the polymer is entirely dissolved and a swelling liquid in which the polymer is swollen. It is to be noted in this heat-dissolution method, the temperature of the swelling liquid is preferably in the range of 50° C. to 120° C. Instead of the heat-dissolution with use of the heating device, the swelling liquid may be cooled in the range of −100° C. to −130° C. so as to perform the dissolution, which is already known as the cool-dissolution method. In this embodiment, one of the heat-dissolution and cool-dissolution methods can be chosen in accordance with the properties of the materials, so as to control the solubility. Thus the dissolution of TAC to the solvent can be made enough. The polymer solution is fed to a temperature controlling device, so as to control the temperature nearly to the room temperature Then the filtration of the polymer solution is made with a filtration device, such that impurities may be removed from the polymer solution. The filter used in the filtration device preferably has an averaged nominal diameter of at most 100 μm. The flow rate of the filtration in the filtration device is preferably at least 50 little/hr. As shown in FIG. 1, the polymer solution after the filtration is accumulated as a dope 22 in a stock tank 21 in a film production line 20 of FIG. 1.

The polymer solution can be used as a dope for a film production, which will be explained. However, in the method in which the dissolution of TAC is performed after the preparation of the swelling liquid, if it is designated that a polymer solution of high concentration is produced, the time for production of such dope becomes longer. Consequently, the production cost becomes higher. Therefore, it is preferable that a polymer solution of the lower concentration than the predetermined value is prepared at first and then the concentrating of the polymer solution is made. In this embodiment, the polymer solution after the filtration is sent to the flushing device. In the flushing device, the solvent of the polymer solution is partially evaporated. The solvent vapor generated in the evaporation is condensed by a condenser (not shown) to a liquid state, and recovered by a recovering device (not shown). The recovered solvent is recycled by a recycling device (not shown) and reused. According to this method, the decrease of cost can be designated, since the production efficiency becomes higher and the solvent is reused.

The polymer solution after the concentrating as the above description is extracted from the flushing device through a pump. Further, in order to remove bubbles generated in the polymer solution, it is preferable to perform the defoaming treatment. As a defoaming method, there are many methods which are already known, for example, an ultrasonic irradiation method and the like. Then the polymer solution is fed to another filtration device, in which the undissolved materials are removed. Note that the temperature of the polymer solution in the filtration is preferably in the range of 0° C. to 200° C. Thus the polymer solution is accumulated as the dope 22 in the stock tank 21.

Thus a dope is produced the produced dope has the TAC concentration in the range of 5 mass % to 40 mass %. The TAC concentration is preferably in the range of 15 mass % to 30 mass %, and especially 17 mass % to 25 mass %. Further, the concentration of the additive (mainly plasticizers) is in the range of 1 mass % to 20 mass %, if the total solid content in the dope is 100 mass %.

Note that the method of producing the polymer solution is disclosed in detail in [0517] to [0616] in Japanese Patent Laid-Open Publication No. 2005-104148, for example, the dissolution method and the adding methods of the materials, the raw materials and the additive in the solution casting method for forming the TAC film, the filtering method, the bubble removing method, and the like.

### [Solution Casting Method]

In followings, a method for producing a film with use of the dope 22 obtained by the above method will be described in reference with FIG. 1 which shows the film production line 20. However, the present invention is not restricted in the film production line 20 of FIG. 1. The film production line 20 includes the stock tank 20, a filtration device 30, a casting die 31, a belt 34 supported by rollers 32, 33, a tenter device 35 and the like. Further, there are a side edge slitting device 40, a drying chamber 41, a cooling chamber 42 and a winding chamber 43.

The stock tank 21 is provided with a motor 60 and a stirrer 61, and is connected through a pump 62 and the filtration device 30 to the casting die 31.

The materials of the casting die 31 are preferably double phase stainless. The preferable material has coefficient of thermal expansion of at most 2×10⁻⁵(° C.⁻¹). Further, the material to be used has an anti-corrosion property, which is almost the same as SUS316, in the examination of forcible corrosion in the electrolyte solution. Preferably, the materials to be used for the casting die 31 has such resistance of corrosion that the pitting doesn't occur on the gas-liquid interface even if the material is dipped in a mixture of dichloromethane, methanol and water for three months. The casting die 31 is preferably manufactured by performing the polishing after a month from the material casting. Thus the surface condition of the dope flowing in the casting die 31 is kept uniform. The finish precision of a contact face of the casting die 31 to solution is at most 1 μm in surface roughness and at most 1 μm in straightness. The clearance of a slit of the casting die 31 is automatically adjustable in the range of 0.5 mm to 3.5 mm. According to an edge of the contact portion of a lip end of the casting die 31 to the dope, R (R is chamfered radius) is at most 50 μm in all of a width. Further, the shearing rate in the casting die 31 is controlled in the range of 1 to 5000 per second.

A width of the casting die 31 is not restricted especially. However, the width is preferably at least 1.1 times and at most 2.0 times as large as a film width. Further, it is preferable to attach a temperature controlling device (not shown) to the casting die 31, such that the temperature may be kept to the predetermined one during the film production. Furthermore, the casting die 31 is preferably a coat hanger type die.

In order to adjust a film thickness, the casting die 31 is preferably provided with an automatic thickness adjusting device. For example, thickness adjusting bolts (heat bolts) are disposed at a predetermined interval in a widthwise direction of the casting die 31. According to the heat bolts, it is preferable that the profile is set on the basis of a predetermined program, depending on feed rate of pumps (preferably, high accuracy gear pumps) 62, while the film production is performed. Further, the feed back control of the adjustment value of the heat bolts may be made by the adjusting program on the base of the profile of a thickness meter (not shown), such as infrared ray thickness meter and the like. The thickness difference between any two points in the widthwise direction except the side edge portions in the casting film is controlled preferably to at most 1 μm. The difference between the maximum and the minimum of the thickness in the widthwise direction is at most 3 μm, and especially at most 2 μm. Further, the accuracy to the designated object value of the thickness is preferably in ±1.5 μm.

Preferably, a hardened layer is preferably formed on a top of the lip end. A method of forming the hardened layer is not restricted. But it is, for example, ceramics hard coating, hard chrome plating, neutralization processing., and the like. If ceramics is used as the hardened layer, it is preferable that the used ceramics is grindable but not friable, with a lower porosity, high resistance of corrosion, and no adhesiveness to the casting die 31. Concretely, there are tungsten carbide (WC), Al₂O₃, TiN, Cr₂O₃, and the like. Especially preferable ceramics is tungsten carbide. Tungsten carbide coating can be made by a spraying method.

Further, in order to prevent the partial dry-solidifying of a dope flowing on a slit end of the casting die 31, it is preferable to provide a solvent supplying device (not shown) at the slit end, on which a gas-liquid interfaces are formed between both edges of the slit and between both bead edges and the outer gas. Preferably, these gas-liquid interfaces are supplied with the solvent which can dissolve the dope, (for example a mixture solvent of dichloromethane 86.5 pts.mass, acetone 13 pts.mass, n-butanol 0.5 pts.mass). The supply rate of the solvent to each bead edge is preferably in the range of 0.1 mL/min to 1.0 mL/min. Thus the solidifications at both bead edges and the mixing of the solid into the casting film are prevented. Note that the pump for supplying the solvent has a pulse rate (or ripple factor) at most 5%.

The belt 34 is positioned below the casting die 31, and lapped on back-up rollers 32, 33. When the back-up rollers 32, 33 are rotated by the driving device (not shown), and thus the belt 34 runs endlessly in accordance with the rotation of the back-up rollers 32, 33. Then the casting speed is preferably in the range of 10 m/min to 200 m/min. Further, the temperatures of the back-up rollers 32, 33 are controlled by a heat transfer medium circulator 75 for cycling a heat transfer medium. It is preferable that the surface temperature of the belt 34 is adjusted in the range of −20° C. to 40° C. by heat transmission from the back-up rollers 32, 33. In this embodiment, paths (not shown) of the heat transfer mediums are formed in the back-up rollers 32, 33, and the heat transfer mediums whose temperatures are controlled by the heat transfer medium circulator 75 pass through the paths. Thus the temperature of the back-up rollers 32, 33 are kept to the predetermined values.

The width and the length of the belt 34 are not restricted especially. However, it is preferably 1.1 to 2.0 times as large as the casting width. Preferably, the length is from 20 m to 200 m, and the thickness is from 0.5 mm to 2.5 mm. The surface is preferably polished so as to have a surface roughness at most 0.05 μm. The belt 34 is preferably made of stainless steel, and especially of SUS316 so as to have enough resistance of corrosion and strength. The thickness unevenness of the entire belt 34 is preferably at most 0.5%.

Note that it is possible to use one of the back-up rollers 32, 33 as support. In this case, the roller is preferably rotated at high accuracy such that a flutter of rotation may be at most 0.2 mm. Therefore the surface roughness is preferably at most 0.01 μm. Further, the chrome plating is preferably performed to the drum such that the drum may have enough hardness and endurance. As described above, it is preferable in the support that the surface defeat must be reduced to be minimal. Concretely there are no pin hole of at least 30 μm, at most one pin hole in the range of 10 μm to 30 μm, and at most two pin holes of less than 10 μm per 1 m².

The casting die 31, the belt 34 and the like are included in a casting chamber 64. A temperature controlling device 65 is provided for controlling the inner temperature of the casting chamber 64 to the predetermined value, and a condenser 66 if provided for condensing organic solvent evaporated in the casting chamber 64. Further, outside the casting chamber 64, there is a recovering device 67 for recovering the condensed organic solvent. In this preferable embodiment, there is a decompression chamber 68 for controlling the pressure in the back side of the bead. Thus the formation of a bead of the cast dope is stabilized.

In this embodiment, it is preferable to provide air blowers 70, 71, 72 for feeding a drying air for evaporating the solvent in the casting film 69 which is transported in accordance with the running of the belt 34. Further, an air shielding device 73 is disposed close to the casting film 69 in the downstream side from the casting die 31. Although the drying wind causes to change surface conditions of the casting film 69 just after the formation, the air shielding device 73 reduces the change of the surface conditions.

In an interval section 80, there is an air blower 81 for feeding a drying air whose temperature is a predetermined value. Further, in downstream from the tenter device 35, there is the edge slitting device 40 to which a crusher 90 for crushing tips of the slit side edge portions of a film 82 is connected. Note that the explanation of the tenter device 35 will be made later.

The drying chamber 41 incorporates many rollers 91. Further to the drying chamber 41 is attached an adsorbing device 92 for adsorbing and recovering the solvent vapor which is generated in the evaporation of the solvent from the film 82. Further, in a downstream from the drying chamber 41, there is the cooling chamber, 42 for cooling the film 82. Furthermore, a humidity control chamber may be provided for conditioning the humidity between the dying chamber and the cooling chamber 42.

In downstream from the drying chamber 41, a compulsory neutralization device (or a neutralization bar) 93 eliminates the charged electrostatic potential of the film 82 to the predetermined value (for example, in the range of −3 kV to +3 kV). The position of the neutralization process is not restricted in this embodiment. For example, the position may be a predetermined position in the drying section or in the downstream side from a knurling roller 94, and otherwise, the neutralization may be made at plural positions. After the neutralization, the embossing of both side portions of the film 82 is made by the embossing rollers to provide the knurling. Further, in the winding chamber 43, there are a winding shaft 95 for winding the film 82 and a press roller 96 for controlling the tension of the film in the winding.

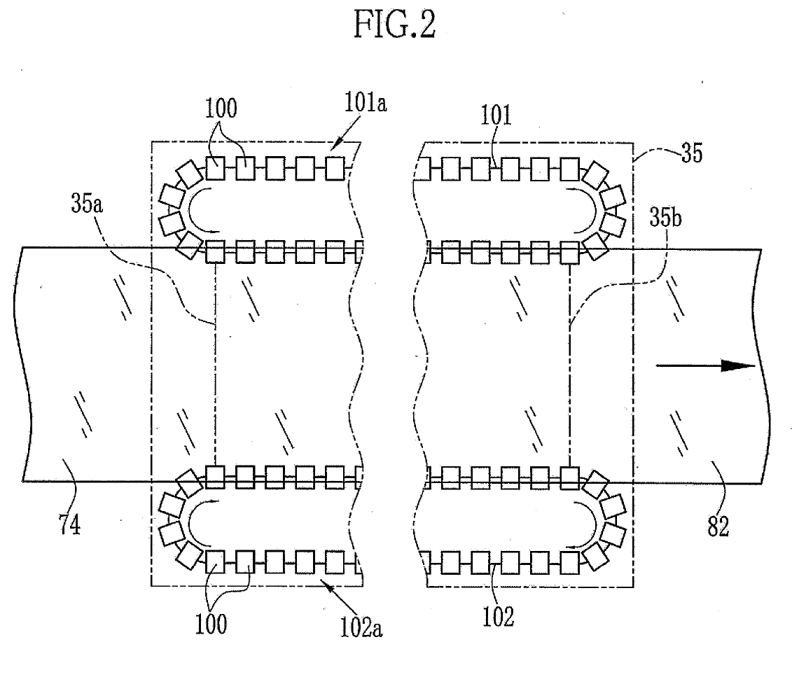

As shown in FIG. 2, the tenter device 35 is provided with tenter chains 101, 102 to which are attached many tenter clips 100 for holding both side edges of the wet film 74. The tenter chains 101, 102 are wound around sprockets (not shown). When the sprockets rotate, the tenter chains 101, 102 move endlessly. The wet film 74 is clipped and held by the tenter clips 100 in a clipping position 35a of the tenter device 35. In the tenter device 35, the wet film 74 is dried during the transportation with clipping both side edge portions thereof with use of the tenter clips 100. Then in a releasing position 35b the tenter clips 100 releases the wet film 74 as film 82, which are fed out from the tenter device 35. The tenter clips 100 pass through returning parts 101a, 102a, and clip the wet film 74 in the clipping position 35a again.

In followings, an embodiment of a producing method of the film 82 with use of the film production line 20 will be described. The dope 22 is always made uniform by rotating the stirrer 61. During the stirring, additive materials of the additive, such as the plasticizer and the UV-absorbing agent and the like, may be added to the dope 22.

The dope 22 is fed to the filtration device 30 by the pump 62, and in the filtration device 30 the filtration of the dope 22 is made. The drive of the rollers 32, 33 is preferably controlled such that a tension of the casting belt 34 may be in the range of 10⁴ N/m to 10⁵ N/m. Thereafter, the dope 22 is cast from the casting die 31 onto the casting belt 34. The relative speed difference between the belt 34 and each back-up roller 32, 33 is at most 0.01 m/min. According to the control of the belt 34, preferably, the change of the running speed is at most 0.5% from the predetermined value, and the meandering in the widthwise direction in one cycle running is at most 1.5 mm. In order to reduce the meandering, a detector (not shown) is preferably provided above each edge portion of the belt 34, so as to make a feed-back control of the position of the belt on the basis of measured values. Furthermore, the position of the belt 34 shifts up- and downwardly in accordance with the rotation of the back-up roller 32. Therefore, it is preferable that the position of the belt 34 is preferably controlled just below the casting die 31, such that a shift range of the belt 34 may be at most 200 μm. The inner temperature is preferably controlled in the range of −10° C. to 57° C. by the temperature controlling device 65. The recovered solvent was recovered by the recovering device 67, and thereafter recycled as a solvent for the dope preparation.

In the present invention, the dope produced as described above is cast to form a casting film 69 on the belt 34. Preferably, the temperatures of the dope is in the range of −10° C. to 57° C. Further, in order to stabilize the formation of a bead of the cast dope, there is the decompression chamber 68 for controlling the pressure in the back side of the bead. The decompression is preferably made such that the pressure difference of a upstream to a downstream side from the bead may be in the range of −10 Pa to −2000 Pa.

It is preferable to provide the decompression chamber 68 with a jacket (not shown) f or controlling the inner temperature. The temperature of the decompression chamber 68 is not restricted especially. However, the temperature is preferably at least the highest melting point of the used organic solvent materials. Further, aspirators (not shown) maybe provided with the decompression chamber 68 so as to be near both side edges of a dope outlet of the casting die 31. Thus the aspiration in both side edges of the bead is made to stabilize the shape of the bead. In this case, the force velocity of the aspiration is preferably in the range of one to one hundred liter/min.

The air blowers 70, 71, 72 feed a wind such that the solvent in the casting film 69 may evaporate more. In this case, although the application of the drying air cause to change surface conditions of the casting film 69 just after the formation, a air shielding device 73 reduces the change of the surface conditions. Note that a drum like the back-up roller may be used as the support, and the surface temperature of the drum is preferably in the range of −20° C. to 40° C.

When the cast dope has self-supporting property, the casting film 69 is peeled as the wet film 74 with support of the peeling roller 75. The content of the remaining solvent at the peeling is preferably in the range of 20 mass % to 250 mass % to the content of the solid materials. Then the wet film 74 is transported in the interval section 80 in which many rollers are provided, and thus transported into the tenter device 35.

In the interval section 80, the air blower 81 feeds a drying air whose temperature is a predetermined value. Thus the drying of the wet film 74 proceeds. At this moment, the temperature of the drying air from the air blower 81 is preferably in the range of 20° C. to 250° C. In the interval section 80, the rotation speed of each roller becomes higher in the upstream side. Thus the draw tension can be applied to the wet film 74 in the transporting direction.

In the tenter device 35, the wet film 74 are held by clipping both side edge portions with use of the tenter clips 100, and the wet film 74 is dried with the transportation. Further, an inside of the tenter device 35 may be partitioned into several temperature zones, so as to dry the wet film 74 at the adequate temperature in each drying zone. The tenter device 35 of this embodiment stretches the wet film 74 in the widthwise direction. Thus, in the interval section 80 and/or the tenter device 35, it is preferable that the wet film 74 is stretched to become larger by 0.5% to 300% in at least one of the transporting direction (or a casting direction) and the widthwise direction.

As shown in FIG. 2, the wet film 74 is clipped in the clipping position 35a of the tenter clip 100. At this time, the solvent content in the wet film is preferably in the range of 80 wt. % to 200 wt. % on dry basis, particularly 80 wt. % to 150 wt. %, and especially 80 wt. % to 130 wt. %. If the solvent content is less than 80 wt. %, the productivity of the film 82 becomes lower. Further, if the solvent content is more than 200 wt. %, the wet film 74 is too soft and therefore several problems, such as tearing and so on, occurs. Further, sometimes the rapid evaporation of the solvent from the wet film 74 causes the foaming.

The temperature of the tenter clips 100 in the clipping part 35a is preferably in the range of 0° C. to 60° C., particularly 10° C. to 50° C., and especially 20° C. to 40° C. If the temperature of the tenter clip 100 is less than 0° C., the dewing occurs on the surface of the tenter clips 100. Further, if the temperature of the tenter clip 100 is more than 60° C., the temperature of both side edges becomes too high, and the solvent contained in the wet film 74 sometimes evaporates rapidly, which causes the foaming.

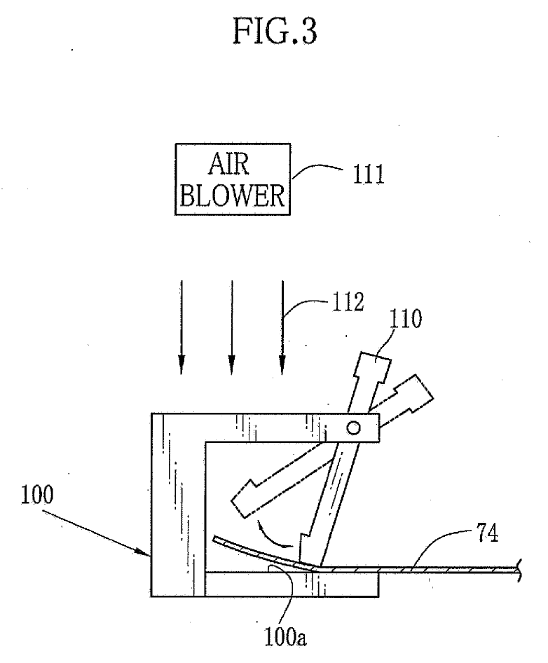

As shown in FIG. 3, a support surface 100a is formed in and a swingable pressing bar 110 (as swingable bar-like member) is swingably attached to the tenter clip 100. When the tenter clip 100 clips the wet film 74, the pressing bar swings from a first position (shown by dotted line) to a second position (shown by continuous line) in a clockwise direction of the figure so as to press the side edge portion of the wet film 74 on the support surface 100a. The surface tension of the support surface 100a is preferably in the range of 3.0×10⁻² N/m to 3.3×10⁻² N/m, and particularly in the range of 3.1×10⁻² N/m to 3.2×10⁻² N/m. When the surface tension is less than 3.0×10⁻² N/m, the wet film 74 is not held stably. When the surface tension is more than 3.3×10⁻² N/m, the foreign materials easily adhere to the support surface 100a. Further, if the foreign materials adhere to the wet film 74, surface defects occur. For the clipping, it is to be noted that the own weight of the pressing bar 110 has effects for pressing the wet film 74 to the support surface 100a by the pressing bar 110. Further, it is preferably to provide a spring (not shown) for biasing the pressing bar 110 so as to press the wet film 74 to the support surface 100a.

Surface hardness Hv (Vickers Hardness) of the support surface 100a is preferably at least 400 HV, particularly at least 500 Hv, and especially at least 700 Hv. If the hardness of the support surface 100a becomes higher, the support surface 100a is hardly scratched. Therefore, the decrease of the holding force that caused by the scratches can be reduced. Further, it is reduced that the wet film 74 adheres to scratches, and therefore the surface defects of the film 82 are reduced. Note that the upper limit of the hardness is not restricted especially. However, it is at most 800 Hv in actual.

The surface roughness (Arithmetical Average Roughness) Ra is preferably in the range of 0.05 μm to 1 μm, particularly in the range of 0.1 μm to 0.8 μm, and especially in the range of 0.2 μm to 0.5 μm. If the surface roughness is less than 0.05 μm, the processing of the tenter clip 100 becomes hard, and the production costs becomes higher. Further, the surface roughness is more than 1 μm, the support surface 100a cannot be smooth and even.

When the plating is made on the support surface 100a, the adhesion of the wet film 74 to the support surface 100a is prevented. As the plating method of the support surface 100a, there are electroplating, vapor plating (for example, evaporation method, sputtering, ion plating, vapor deposition, and the like) and the like. Concretely, when it is designated to produce the tenter clip 100 from the SUS materials, a thin layer of about 20 μm in thickness is formed by electroless nickel plating.

While the wet film 74 is held with the tenter clips 100 between the clipping and the releasing, it is preferable to blow a wind 112 from an air blower 111. Thus the concentration of the volatile materials can be made lower near the tenter clips 100, and therefore the precipitation of the contents (such as plasticizer and the like) on the tenter clip 100 is reduced. The wind 112 is preferably a fresh wind. However, gas concentration in the wind 112 may be at most 10%, preferably at most 5%, and especially 1%.

The blowing temperature of the wind 112 to the tenter clip 100 is preferably in the range of 30° C. to 70° C., particularly in the range of 35° C. to 65° C., and especially in the range of 40° C. to 60° C. If the blowing temperature is less than 30° C., clipped areas of the wet film 74 by the tenter clip 100 dry slowly. In this case, the wet film 74 sometimes tears. Further, the blowing temperature is more than 70° C. the evaporation of the solvent causes the foaming on both side edge portions of the wet film 74, which causes the surface defect of the film 82.

The wet film 74 is dried until the content of the remaining solvent become the predetermined value, and fed out as film 82 from the tenter device 35 toward the edge slitting device 40 for slitting off both side edge portions. The slit side edge portions are sent to a crusher 90 by a cutter blower (not shown), and crushed to tips by the crusher 90. The tips are reused for preparing the dope, which is effective in view of the decrease of the production cost. Note that the slitting process of both side edge portions may be omitted. However, it is preferable to perform the slitting between the casting process and the winding process.

The film 82 whose side edge portions are slit off is sent to the drying chamber 41 and dried furthermore. In the drying chamber 41, the film 82 is transported with lapping on rollers 91. The inner temperature of the drying chamber 41 is not restricted especially. However, it is preferable in the range of 50° C. to 160° C. The solvent vapor evaporated from the film 82 by the drying chamber 41 is adsorbed by the adsorbing device 92. The air from which the solvent components are removed is reused for the drying air in the drying chamber 41. Note that the drying chamber 41 preferably has plural partitions for variation of the drying temperature. Further, a pre-drying device (not shown) is provided between the edge slitting device 40 and the drying chamber 41, so as to perform the pre-drying of the film 82. Thus it is prevented that the temperature of the film 82 increases rapidly, and therefore the change of the shape of the film 82 is reduced.

The film 82 is transported toward the cooling chamber 42, and cooled therein to around the room temperature. A humidity control chamber (not shown) may be provided for conditioning the humidity between the drying chamber 41 and the cooling chamber 42. Preferably, in the humidity control chamber, an air whose temperature and humidity are controlled is applied to the film 82. Thus the curling of the film 82 and the winding defect in the winding process can be reduced.

Thereafter, the compulsory neutralization device (or a neutralization bar) 93 eliminates the charged electrostatic potential of the film 82 to the predetermined value (for example, in the range of −3 kV to +3 kV). The position of the neutralization process is not restricted in this embodiment. For example, the position may be a predetermined position in the drying section or in the downstream side from the knurling roller 94, and otherwise, the neutralization may be made at plural positions. After the neutralization, the embossing of both side portions of the film 82 is made by the embossing rollers to provide the knurling. The emboss height from the bottom to the top of the embossment is in the range of 1 μm to 200 μm.

In the last process, the film 82 is wound by the winding shaft 95 in the winding chamber 43. At this moment, a tension is applied at the predetermined value to a press roller 96. Preferably, the tension is gradually changed from the start to the end of the winding. In the present invention, the length of the film 82 is preferably at least 100 m. The width of the film is preferably at least 600 mm, and particularly in the range of 1400 mm to 1800 mm. Further, even if the width is more than 1800 mm, the present invention is effective. Even if the thickness is in the range of 15 μm to 100 μm, the present invention can be applied.

In the solution casting method of the present invention, there are casting methods for casting plural dopes, for example, a co-casting method and a sequential casting method. In the co-casting method, a feed block may be attached to the casting die as in this embodiment, or a multi-manifold type casting die (not shown) may be used. In the production of the film having multi-layer structure, the plural dopes are cast onto a support to form a casting film having a first layer (uppermost layer) and a second layer (lowermost layer). Then in the produced film, at least one of the thickness of the first layer and that of the lowermost layer opposite thereto is preferably in the range of 0.5% to 30% of the total film thickness. Furthermore, when it is designated to perform the co-casting, a dope of higher viscosity is sandwiched by lower-viscosity dopes. Concretely, it is preferable that the dopes for forming the surface layers have lower viscosity than the dope for forming a layer sandwiched by the surface layers. Further, when the co-casting is designated, it is preferable in the bead between a die slit (or die lip) and the support that the composition of alcohol is higher in the two outer dopes than the inner dope.

Japanese Patent Laid-Open Publication No. 2005-104148 describes from [0617] to [0889] in detail about the structures of the casting die, the decompression chamber, the support and the like, and further about the co-casting, the peeling, the stretching, the drying conditions in each process, the handling method, the curling, the winding method after the correction of planarity, the solvent recovering method, the film recovering method. The descriptions thereof can be applied to the present invention.

### [Properties & Measuring Method]

(Degree of Curl & Thickness)

Japanese Patent Laid-Open Publication No. 2005-104148 describes from [0112] to [0139] about the properties of the wound cellulose acylate film and the measuring method thereof. The properties and the measuring methods can be applied to the present invention.

### [Surface Treatment]

The cellulose acylate film is preferably used in several ways after the surface treatment of at least one surface. The preferable surface treatments are vacuum glow discharge, plasma discharge under the atmospheric pressure, UV-light irradiation, corona discharge, flame treatment, acid treatment and alkali treatment. Further it is preferable to make one of these sorts of the surface treatments.

### [Functional Layer]

(Antistatic, Curing, Antireflection, Easily Adhesive & Antiglare Layers)

The cellulose acylate film may be provided with an undercoating layer on at least one of the surfaces, and used in the several ways.

It is preferable to use the cellulose acylate film as a base film to which at least one of functional layers may be provided. The preferable functional layers are an antistatic layer, a cured resin layer, an antireflection layer, an easily adhesive layer, an antiglare layer and an optical compensation layer.

Conditions and Methods for forming the functional layer are described in detail from [0890] to [1087] of Japanese Patent Laid-Open Publication No. 2005-104148, which can be applied to the present invention. Thus, the produced film can have several functions and properties.

These functional layers preferably contain at least one sort of surfactants in the range of 0.1 mg/m² to 1000 mg/m². Further, the functional layers preferably contain at least one sort of plasticizers in the range of 0.1 mg/m² to 1000 mg/m². The functional layers preferably contain at least one sort of matting agents in the range of 0.1 mg/m² to 1000 mg/m². The functional layers preferably contain at least one sort of antistatic agents in the range of 1 mg/m² to 1000 mg/m².

(Variety of Use)

The produced cellulose acylate film can be effectively used as a protection film for a polarizing filter. In the polarizing filter, the cellulose acylate film is adhered to a polarizer. Usually, two polarizing filters are adhered to a liquid crystal layer such that the liquid crystal display may be produced. Note that the arrangement of the liquid crystal layer and the polarizing filters are not restricted in it, and several arrangements already known are possible. Japanese Patent Laid-Open Publication No. 2005-104148 discloses the liquid crystal displays of TN type, STN type, VA type, OCB type, reflective type, and other types in detail. The description may be applied to the present invention. Further, in this publication No. 2005-104148 describes a cellulose acylate film provided with an optical anisotropic layer and that having antireflection and antiglare functions. Further, the produced film can be used as an optical compensation film since being double axial cellulose acylate film provided with adequate optical properties. Further, the optical compensation film can be used as a protective film for a polarizing filter. The detail description thereof is made from [1088] to [1265] in the publication No. 2005-104148.

In the method of forming the polymer film of the present invention, the formed cellulose acylate film is excellent in optical properties. The TAC film can be used as the protective film for the polarizing filter, a base film of the photosensitive material, and the like. Further, in order to improve the view angular dependence of the liquid crystal display (used for the television and the like), the produced film can be also used for the optical compensation film. Especially, the produced film is effectively used when it doubles as protective film for the polarizing filter. Therefore, the film is not only used in the TN-mode as prior mode, but also IPS-mode, OCB-mode, VA-mode and the like. Further, the polarizing filter may be constructed so as to have the protective film as construction element.

In followings, Experiment of the present invention will be explained. However, the present invention is not restricted in it. The explanation will be made in detail according to Example 1. The experimental conditions and results of Examples 2-5 and Example 6 as Comparison will be shown in Table 1.

### [Experiment]

The composition of the dope (or polymer solution) used for the film production will be shown.

(Composition)

| | | |
|---|---|---|
| Cellulose Triacetate | 100 | pts. mass |
| (Powder: degree of substitution, 2.84; viscosity- | | |
| average degree of polymerization, 306; water | | |
| content, 0.2 mass %; viscosity of 6 mass % | | |
| dichloromethane solution, 315 mPa · s; | | |
| averaged particle diameter, 1.5 mm; standard | | |
| deviation of particle diameter, 0.5 mm) | | |
| Dichloromethane (first solvent compound) | 320 | pts. mass |
| Methanol (second solvent compound) | 83 | pts. mass |
| 1-butanol (third solvent compound) | 3 | pts. mass |
| Plasticizer A (triphenylphosphate) | 7.6 | pts. mass |
| Plasticizer B (diphenylphosphate) | 3.8 | pts. mass |
| UV-agent A | 0.7 | pts. mass |
| (2(2′-hydroxy-3′,5′-di-tert-butylphenyl)-5-benzotriazol) | | |
| UV-agent B | 0.3 | pts. mass |
| (2(2′-hydroxy-3′,5′-di-tert-amylphenyl)-5- | | |
| chlorobenzotriazol) | | |
| Mixture of citric acid esters | 0.006 | pts. mass |
| (Mixture of citric acid, citric acid monoethyl ester, | | |
| citric acid dimethyl ester, citric acid triethyl ester) | | |
| Particles | 0.05 | pts. mass |
| (particle diameter, 15 nm; Mohs Hardness, about 7) | | |

### [Cellulosetriacetate]

According to cellulose triacetate used in this experiment, the remaining content of acetic acid was at most 0.1 mass %, the Ca content was 58 ppm, the Mg content was 42 ppm, the Fe content was 0.5 ppm, the free acetic acid was 40 ppm, and the sulfuric ion content was 15 ppm. The degree of acetylation at 6^{th} position was 0.91, and the percentage of acetyl groups at 6^{th} position to the total acetyl groups was 32.5%. The acetone extract was 8 mass %, and a ratio of weight-average molecular weight to number-average molecular weight was 2.5. Further, yellow index was 1.7, haze was 0.08, and transparency was 93.5%. Tg (measured by DSC) was 160° C., and calorific value in crystallization was 6.4 J/g. This cellulose triacetate is synthesized from cellulose as material obtained from cotton, and called cotton TAC in the following explanation.

(1) Preparation of Dope

The polymer solution was prepared with use of the dissolution tank having first and second stirrers that was made of stainless and 4000 L in volume. Into the dissolution tank, plural solvent compounds were mixed such that a mixture solvent was obtained. While the stirring of the mixture solvent was made, the cellulose triacetate flakes were added from the hopper to the mixture solvent gradually, such that the total mass of the mixture solution and the cellulose triacetate flakes might be 2000 kg. Note that the water content in each solvent compound is at most 0.5 mass %. The stirring was made with use of the first stirrer having the anchor blade and the second stirrer which was eccentric stirrer of dissolver type. At first, the first stirrer performed the stirring at one m/sec as circumferential velocity, and the second stirrer performed the stirring at shear rate at first 5 m/sec. Thus the dispersion was made for 30 minutes during the stirring. The dissolving started at 25° C., and the temperature of the dispersion became 48° C. at last. After the dispersion, the high speed stirring (of the second stirrer) was stopped, and the stirring was performed by the first stirrer at 0.5 m/sec as circumferential velocity for 100 minutes. Thus cellulose triacetate flakes was swollen such that the swelling liquid was obtained. Until the end of the swelling, the inner pressure of the dissolution tank was increased to 0.12 MPa with use of nitrogen gas. At this moment, the hydrogen concentration in the dissolution tank was less than 2 vol. %, which does not cause the explosion. Further, water content in the polymer solution was 0.3 mass %.

(2) Dissolution & Filtration

The swelling liquid was fed to the heating device which is the tube with the jacket, and heated to 50° C., and thereafter heated under the application of pressure at 2 MPa to 90″C. Thus the dissolving was made completely. The heating time was 15 minutes. The temperature of the swelling liquid is decreased to 36° C. by the temperature controlling device, and then filtrated through the filtration device having filtration material whose nominal diameter was 8 μm. Thus the content of solid compounds was 19 mass %. At this moment, the upstream side filtration pressure was 1.5 MPa, and the downstream side filtration pressure was 1.2 MPa. Since the filter, the housing and the pipes were made of hastelloy alloy and used at high temperature, they were made from materials excellent in corrosion resistance. Further, the jacket had endurance even if the heating medium for keeping or increasing the temperature was fed into the jacket.

(3) Condensation, Filtration & Defoaming

The polymer solution was fed into the flushing device whose pressure was kept to the atmospheric pressure at 80° C., such that the flush evaporation of the polymer solution was made The solvent vapor was condensed by the condenser to the liquid state, and recovered by the recovering device. After the flushing, the content of solid compounds in the polymer solution was 21.8 mass %. Note that the recovered solvent was recycled by the recycling device and reused. The anchor blade is provided at a center shaft of a flush tank of the flushing device, and the polymer solution was stirred by the anchor blade at 0.5 m/sec as circumferential velocity. The temperature of the polymer solution in the flush tank was 25° C., the retaining period of the polymer solution in the flush tank was 50 minutes. Part of the polymer solution was sampled, and the measurement of the shearing viscosity was made at 25° C. The shearing viscosity was 450 Pa·s at 10 (1/s) of shearing rate.

Then the defoaming was further made by irradiating very weak ultrasonic waves. Thereafter, the polymer solution was fed to the filtration device by the pump under the application of pressure at 1.5 MPa. In the filtration device, the polymer solution was fed at first through a sintered fiber metal filter whose nominal diameter was 10 μm, and then through the same filter of 10 μm nominal diameter. At the forward and latter filters, the upstream side filtration pressures were respectively 1.5 MPa and 1.2 MPa, and the downstream side filtration pressures were respectively 1.0 MPa and 0.8 MPa. The temperature of the polymer solution after the filtration was controlled to 36° C., and stored as the dope 22 in the stainless stock tank 21 whose volume was 2000 L. The anchor blade is provided to a center shaft of the stock tank 21, and the dope 22 was always stirred by the anchor blade at 0.3 m/sec as circumferential velocity. Note that when the concentrating of the polymer solution is made, corrosions of parts or portions contacting to the polymer solution in the devices didn't occur at all. Further, the mixture solvent A for preparing the additive liquid contained dichloromethane of 86.5 pts.mass, acetone 13 pts.mass, and n-butanol 0.5 pts.mass.

(4) Discharging

The film is formed in a film manufacturing line 20 shown in FIG. 1. The pump 62 for increasing the primary pressures was high accuracy gear pumps and driven to feed the dope 22 while the feed back control was made by an inverter motor. Thus an upstream side pressure of high accuracy gear pump was controlled to 0.8 MPa. As for the pump 62, volumetric efficiency was 99.2%, and the variation rate of the discharging was at most 0.5%. Further, the discharging pressure was 1.5 MPa.

The width of the casting die 31 was 1.8 m, The flow rate of the dope 22 near a die lip of the casting die 31 is controlled such that the dried film may be 80 μm in thickness. The casting width of the dope 22 from the die lip was 1700 mm. The casting speed was 60 m/min. Further, in order to control the temperature of the dope 22 to 36° C., the temperature of the heat transfer medium at an entrance of the jacket was 36° C.

The casting die 31 was the coat hunger type, in which heat bolts for adjusting the film thickness were disposed at the pitch of 20 mm. Thus the film thickness (or the thickness of the dopes) is automatically controlled by the heat bolt. A profile of the heat volt can be set corresponding to the flow rate of the high accuracy gear pump, on the basis of the preset program. Thus the feed back control can be made by the control program on the basis of the profile of an infrared ray thickness meter (not shown) disposed in the film production line 40. The control was made such that, with exception of both side edge portions (20 mm each in the widthwise direction of the produced film), the difference of the film thickness between two positions which were 50 mm far from each other might be at most 1 μm, and the largest difference between the minimal values of the film thickness in the widthwise direction might be at most 3 μm/m. Further, the average film thickness might was controlled in ±1.5%.

In the upstream side of the casting die 31, there is the decompression chamber 68. The decompression rate of the decompression chamber 68 was controlled in accordance with the casting speed, such that the pressure difference might occur in the range of one Pa to 5000 Pa between the upstream and downstream sides of the bead of the cast dope above the casting die. At this time, the pressure difference between both side of a bead of the cast dope was determined such that the length of the bead might be from 20 mm to 50 mm. Further, an instrument was provided such that the temperature of the decompression chamber 68 might be set to be higher than the condensation temperature of the gas around the casting section. Further, there were labyrinth packings (not shown) in the upstream and downstream sides of the beads. Further, an opening was provided in both edges. Further, an edge suctioning device (not shown) for reducing the disturbance of the bead was provided.

(5) Casting Die

The material of the casting die 31 was the double layer stainless alloy, whose coefficient of thermal expansion was at most 2×10⁻⁵ (° C.⁻¹). In the compulsory corrosion experiment in an electrolyte solution, the corrosion resistance was almost the same as that of SUS316. Further, the material to be used for the casting die 31 had enough corrosion resistance, such that the pitting (or pitting corrosion) might not occur on the gas-liquid interface even if this material were dipped in a mixture liquid of dichloromethane, methanol and water for three months. The finish accuracy of the contact surface of each casting die to the dope 22 was at most 1 pm in surface roughness, and the slit clearance was adjusted to 1.5 mm in straightness. According to an edge of the contact portion of a lip end of the casting die 31, R is at most 50 μm in all of a width. Further, the shearing rate in the casting die 31 controlled in the range of one to 5000 per second. Further, the WC coating was made on the lip end from the casting die 31 by a melt extrusion method, so as to provide the hardened layer.

In order to prevent the dry and solidification on part of the slit end of the casting die 31, the mixture solvent dissolvable of the solidified dope was supplied to each edge portion of the gas-liquid interface of the slit at 0.5 ml/min. Thus the mixture solvent A is supplied to each bead edge. The pulse rate of a pump for supplying the mixture solvent was at most 5%. Further, the decompression chamber 68 was provided for decreasing the pressure in the rear side by 150 Pa. In order to control the temperature of the decompression chamber 68, a jacket (not shown) was provided, and a heat transfer medium whose temperature was controlled at 35° C. was supplied into the jacket. The edge suction rate could be controlled in the range of 1 L/min to 100 L/min, and was adequately controlled in this experiment so as to be in the range of 30 L/min to 40 L/min.

(6) Metal Support

The belt 34 was an endless stainless belt which was 2.1 m in width and 70 m in length. The thickness of the belt 34 was 1.5 mm, and the surface of the belt 34 was polished, such that the surface roughness might be at most 0.05 μm. The material was SUS316, which had enough corrosion resistance and strength. The thickness unevenness of the entire belt 34 was at most 0.5% of the predetermined value. The belt 34 was moved by rotating the back-up rollers 32, 33. At this moment, the tension of the belt 34 was controlled to 1.5×10⁵ N/m². Further, the relative speed to each roller to the belt 34 changed. However, in this experiment, the control was made such that the difference of the relative speed between the back-up rollers 32, 33 was at most 0.01 m/min. Further the control was made such that the variation of the speed of the belt 34 was at most 0.5% to the predetermined value. The position of the belt in the widthwise direction was controlled with detection of the position of the side end, such that meandering in one circle of the moving belt 34 was reduced in 1.5 mm. Further, below the casting die 31, the variation of the position in the vertical direction between the lip end of the casting die 31 and the belt 34 was in 200 μm. The belt 34 is preferably incorporated in the casting chamber 64 which has air pressure controller (not shown). The dope was cast onto the belt 34 from the casting die 31.

In this experiment, the back-up rollers 32, 33 were supplied therein with a heat transfer medium, such that the temperature of the belt 34 might be controlled. The back-up roller 33 disposed in a side of the casting die 31 was supplied with the heat transfer medium (water) at 5° C., and the back-up roller 32 was supplied with the heat transfer medium (water) at 40° C. The surface temperature of the middle portion of the belt 34 at a position just before the casting was 15° C., and the temperature difference between both sides of the belt was at most 6° C. Note that a number of pinhole (diameter, at most 30 μm) was zero, a number of pinhole (diameter, 10 μm to 30 μm) was at most one in square meter, and a number of pinhole (diameter, less than 10 μm) was at most two in square meter.

(7) Casting & Drying

The temperature of the casting chamber 77 controlled to 35° C. by the temperature controlling device 76. The dope was cast onto the belt 34 to form the casting film 69, and the drying air was fed out as parallel air wind to the casting film 69 from the air blower 70. The overall heat transfer coefficient from the drying air to the belt 34 was 24 kcal/(m²·hr·° C.). Above the belt 34, the temperature of the drying air was 135° C. in the upstream side and 140° C. in the downstream side. Further, below the belt 34, the temperature of the drying air was 65° C. The saturation temperature of each air was around −8° C. The oxygen concentration in the drying atmosphere on the belt 34 was kept at 5 vol. %. In order to keep the oxygen concentration at 5 vol. %, the air was substituted by the nitrogen gas. Further, in order to condense and recover the solvent in the casting chamber 64, the condenser 66 was provided, and the temperature of the exit was set to −10° C.

The air shielding device 73 was disposed such that the drying air might not be directly applied to the bead of the cast dope or the casting film 69 for 5 seconds after the casting. Thus the variation of the static pressure near the casting die 31 was reduced in ±1 Pa. When the solvent content in the casting film 69 became 50 mass % on dry basis, the casting film 69 was peeled as the wet film 74 from the belt 34 by the peeling roller 75. About the solvent content, it was necessary to sample part of the film and dry the sample. If the sample weight at the sampling was x and the sample weight after the drying was y, the solvent content on the dry basis was calculated in the formula, {(x−y)/y}×100. Further, the peeling tension was 1×10² N/m². In order to reduce the peeling defects, the percentage of the peeling speed (the draw of the peeling roller) to the speed of the belt 34 was controlled from 100.1% to 110%. The surface temperature of the wet film 74 was 15° C. The drying speed on the casting belt 34 was 60 mass %/min in average on dry basis. The solvent vapor generated in the evaporation is condensed by the condenser 66 at −10° C. to a liquid state, and recovered by the recovering device 67. The water content of the recovered solvent was adjusted to at most 0.5%. Further, the air from which the solvent components were removed was heated again and reused for the drying air. The wet film 74 was transported with the rollers in the interval section 80 toward the tenter device 35. In the clipping position 35a of the tenter device 35, the solvent content of the wet film 74 was 100 wt. %. In the interval section 80, the air blower 81 fed the drying air at 40° C. out to the wet film 74. Note that the tension about 30N was applied to the wet film 74 in the transportation of the rollers in the interval section 80.

The tenter clip 100 was formed from SUS material as a raw material. The temperature of the tenter clip 100 was controlled to 40° C. during holding the wet film 74. The plating was made such that the surface tension of the support surface 100a of the tenter clip 100 might be 3.1×10⁻² N/m, the surface roughness Ra was 0.3 μm, and the surface hardness was 700 Hv. The plating method was the electroless nickel plating. On the surface, a thin layer (about 20 μm in thickness) including electroless nickel layer in which particles of Teflon (trademark) was uniformly distributed was formed, and the heating treatment of the thin layer was made.

(8) Tenter Transporting, Drying, Slitting

The wet film 74 fed into the tenter device 35 was transported into the drying zone of the tenter device 35 and dried with use of the drying air, while both side edges of the wet film 74 was held by the tenter clips 100. The temperature of the tenter clips 100 was controlled by feeding the heat transfer medium at 40° C. Further, the wind 112 was applied to the tenter clips 100 by the air feeder 111. Note that the gas content in the wind 112 was 5%, the temperature was 35° C. The wind 112 was applied to the tenter clip 100 with a wind speed of 2 m/s. The transference of the tenter clips 100 was made with use of chain, and the speed fluctuation of the sprocket was at most 0.5%.

The drying chamber 41 was partitioned into three zones. The temperature of the drying air in each zone was 90° C., 110° C., 120° C. from the upstream side. The gas concentration in the drying air at −10° C. was the saturated gas concentration. The averaged drying speed in the tenter device 35 was 120 mass %/min on the dry basis. The condition of each zone was controlled such that the content of the remaining solvent in the film 82 might be 7 mass % at the exit of the tenter device 35. In the tenter device 35, the stretching of the wet film 74 in the widthwise direction was made as the transportation was made. If the percentage of the film width before the tenter device 35 was determined to 100% the stretching ratio of the film width after the tenter device 35 was 103%. Further, the wet film 74 was drawn in the lengthwise direction between the peel roller 86 and the tenter device 35. The drawing ratio in percentage was 102%.

According to the stretching ratio in the tenter device 35, the difference of the actual stretching ratio was at most 10% between two positions which were at least 10 mm apart from the clipping position of the clips, and at most 5% between two positions which were 20 mm apart from the holding portions. In the side edge portions in the tenter device 35, the ratio of the length in which the fixation was made was 90%. The solvent vapor generated in the tenter device 35 was condensed at −10° C. to a liquid state and recovered. For the condensation, a condenser (not shown) was provided, and a temperature at an exit thereof was −8° C. The water content in the recovered solvent was regulated to at most 0.5 mass %, and then the recovered solvent was reused. The wet film 87 was fed out as the film 82 from the tenter device 35.

In 30 seconds from exit of the tenter device 35, both side edge portions were slit off in the edge slitting device 40. In this experiment, each side portion of 50 mm in the widthwise direction of the wet film 74 was determined as the side edge portion, which were slit off by an NT type cutter of the edge slitting device 40. The slit side edge portions were sent to the crusher 90 by applying air blow from a blower (not shown), and crushed to tips about 80 mm². The tips were reused as raw material with the TAC frame for the dope production. The oxygen concentration in the drying atmosphere in the tenter device 35 was kept to 5 vol. %. Note that the air was substituted by nitrogen gas in order to keep the oxygen concentration at 5 vol. %. Before the drying at the high temperature in the drying chamber 41, the pre-heating of the film 82 was made in a pre-heating chamber (not shown in which the air blow at 100° C. was supplied.

(9) Drying & Neutralization

The film 82 was dried at high temperature in the drying chamber 41, which was partitioned into four partitions. Air blows whose temperatures were 120° C., 130° C., 130° C. and 130° C. from the upstream side were fed from air blowers (not shown) to the partitions. The transporting tension of each roller 91 to the film 82 was 100 N/m. The drying was made for ten minutes such that the content of the remaining solvent might be 0.3 mass %. The lapping angle of the roller 4 was 90° and 180°. The rollers 91 were made of aluminum or carbon steel. On the surface, the hard chrome coating was made. The surfaces of the rollers 91 were smooth or processed by blast of matting process. The swing of the roller in the rotation was in 50 μm. Further, the bending of the roller 91 at the tension of 100 N/m was reduced to at most 0.5 mm.

The solvent vapor contained in the drying air is removed with use of the adsorbing device 92 in which an adsorbing agent was used. The adsorbing agent was active carbon, and the desorption was performed with use of dried nitrogen. The recovered solvent was reuse as the solvent for the dope preparation after the water content might be at most 0.3 mass %. The drying air contains not only the solvent vapor but also gasses of the plasticizer, UV-absorbing agent, and materials of high boiling points. Therefore, a cooler for removing by cooling and a preadsorber were used to remove them. Thus the drying air was reused. The ad- and desorption condition was set such that a content of VOC (volatile organic compound) in exhaust gas might be at most 10 ppm. Furthermore, in the entire solvent vapor, the solvent content to be recovered by condensation method was 90 mass %, and almost of the remaining solvent vapor was recovered by the adsorption recovering.

The film 82 was transported to a first moisture controlling chamber (not shown). In the interval section between the drying chamber 41 and the first moisture controlling chamber, the drying air at 110° C. was fed. In the first moisture controlling chamber, the air whose temperature was 50° C. and dewing point was 20° C. was fed. Further, the film 82 was fed into a second moisture chamber (not shown) in which the curling of the film 82 was reduced. An air whose temperature was 90° C. and humidity was 70% was applied to the film 82 in the second moisture controlling chamber.

(10) Knurling & Winding

After the moisture adjustment, the film 82 was cooled to at most 30° C. in the cooling chamber 107, and then the edge slitting was performed. The compulsory neutralization device (or a neutralization bar) 93 was provided, such that in the transportation, the charged electrostatic potential of the film might be in the range of −3 kV to +3 kV. Further, the film knurling was made on a surface of each side of the film 82 by the knurling roller 94. The width of the knurling was 10 mm, and the knurling pressure was set such that the height from bottom to top of the film surface might be at most 12 μm larger in average than the averaged thickness.

The film 82 was transported to a winding chamber 110, whose inside temperature and humidity were respectively kept to 28° C. and 70%. Further, a compulsory neutralization device (not shown) was provided, such that the charged electrostatic potential of the film might be in the range of −1.5 kV to +1.5 kV. The obtained film 82 was 1475 mm in width. The diameter of the winding shaft 95 was 169 mm. The tension pattern was set such that the winding tension was 300 N/m at first, and 200 N/m at last. The film 82 was entirely 3940 m in length. The cycle of winding dislocation was 400 m, and the oscillation width was in ±5 mm. Further, the pressure of the press roller 96 to the winding shaft 95 was set to 50N/m. The temperature of the film at the winding was 25° C., the water content was 1.4 mass %, and the content of the remaining solvent was 0.3 mass %. The film production was continuously made for 8760 hours. Through all processes, according to the drying speed, 20 mass % of the solvent in dry weight standard was evaporated per minute in average. Further, the loose winding and wrinkles didn't occur, and the film didn't transit in the film roll even in 10 G impact test. Further, the roll appearance was good.

The film roll of the film 82 is stored in the storing rack of 55% RH at 25° C. for one month. Then the inspection was made in the same way as above, but the remarkable change of the film conditions was not recognized. Further, the adhesion of the film didn't occur in the film roll. After production of the film 82, any part of the casting film 69 formed of the dope was not recognized on the belt 34.

The pollution of the tenter clips 100 was observed with eyes, and the estimation of four grades was made as follows.
A; There were no pollutions.
B; The tenter clips were extremely slightly polluted, which has no influence on the film production.
C; The tenter clips were slightly polluted, which has no influence on the film production.
F; The tenter clips were clearly polluted, which has influences on the film production.
   In Example 1 as there were no pollution, the estimation was A.

TABLE 1

| | SC_{hold} | CT_{hold} | ST | Ra | | | |
|---|---|---|---|---|---|---|---|
| | (wt. %) | (° C.) | (×10⁻² N/m) | (μm) | Hv | FW | Est. |
| Ex. 1 | 100 | 40 | 3.1 | 0.3 | 700 | feed | A |
| Ex. 2 | 100 | 40 | 3.1 | 0.1 | 700 | none | B |
| Ex. 3 | 100 | 40 | 3.1 | 0.1 | 500 | feed | B |
| Ex. 4 | 100 | 40 | 3.1 | 0.3 | 500 | none | B |
| Ex. 5 | 100 | 40 | 3.1 | 0.1 | 500 | none | C |
| Ex. 6 | 100 | 40 | 3.5 | 0.1 | 500 | none | F |

SC_{hold}; solvent content at holding the wet film
CT_{hold}; Temperature of the tenter clip at holding the wet film
ST; Syrface tension of the support surface of the tenter clip
Ra; Surface roughness of the support surface of the tener clip
Hv; Surface hardness of the support surface of the tener clip
FW; Whether the wind was fed

In Example 5, the surface tension of the support surface of the tenter clip 100 was 3.1×10⁻² N/m, and the pollution of the tenter clip 100 was slightly observed. Therefore the estimation was C. In Example 2, the surface hardness of the holding surface of the tenter clip was 700 Hv. In Example 3 the wind was fed toward the tenter clips. In Example 4, the surface roughness Ra of the support surface of the tener clip was 0.3 μm. In these examples, the pollution was extremely slightly observed, and the estimations were B. In Example 1, the surface tension was 3.1×10⁻² N/m, the surface roughness Ra was 0.3 μm, the surface hardness was 700 Hv, and the wind was fed to the tenter clip 100. In this example, there were no pollutions.

Various changes and modifications are possible in the present invention and may be understood to be within the present invention.

### INDUSTRIAL APPLICABILITY

The present invention is not restricted in that the tenter device having the tenter clips is used in the solution casting method. For example, the present invention is applicable to a film production method, such as a melt extrusion method.

1. A tenter clip provided in a tenter device for clipping both side edge portions of a film to hold said film while said tenter device stretching said film in a widthwise direction, said tenter clip comprising:
a clipping surface for clipping each of said side edge portions in the clipping, a surface tension of said clipping surface being in the range of 3.0×10⁻² N/m to 3.3×10⁻² N/m.

2. A tenter clip according to claim 1, wherein surface .hardness of said clipping surface is in the range of 400 Hv to 800 Hv.

3. A tenter clip according to claim 1, wherein surface roughness Ra of said clipping surface is in the range of 0.05 μm to 1 μm.

4. A tenter clip according to claim 1, wherein a plating is made on said clipping surface.

5. A tenter clip according to claim 1, further comprising a bar-like member swinging from a first position for releasing said wet film to a second position for clipping said wet film so as to press each of said side edge portions of said wet film onto said support member in performance of the clipping.

6. A solution casting method comprising steps of:
casting on a support a dope containing polymer and solvent, so as to form a casting film;
peeling said casting film as a wet film from said support;
clipping side edge portions of said wet film with tenter clips provided in a tenter device, a clipping surface of each of said tenter clip having surface tension in the range of 3.0×10⁻² N/m to 3.3×10⁻² N/m;
stretching said wet film by moving said tenter clip; and
releasing the clipping of said wet film after the stretching, so as to obtain a film.

7. A solution casting method according to claim 6, wherein surface hardness of said clipping surface is in the range of 400 Hv to 800 Hv.

8. A solution casting method according to claim 6, wherein surface roughness Ra of said clipping surface is in the range of 0.05 μm to 1 μm.

9. A solution casting method according to claim 6, wherein a plating is made on said clipping surface.

10. A solution casting method according to claim 6, wherein said tenter clip has a bar-like member, said bar-like member swings from first position for releasing said wet film to a second position for clipping said wet film to press said side edge portion of said wet film onto said support member when the clipping is performed.

11. A solution casting method according to claim 6, further comprising:
drying said wet film by blowing a wind near said tenter clip between holding and releasing said wet film.

12. A solution casting method according to claim 11, wherein a blowing temperature of said wind is in the range of 30° C. to 70° C.

13. A solution casting method according to claim 6, wherein a content of solvent in said wet film at the clipping is in the range of 80 wt. % to 200 wt. % on dry basis.

14. A solution casting method according to claim 6, wherein a temperature of said tenter clip is in the range of 0° C. to 60° C.
